(19) United States
(12) Patent Application Publication
(10) Pub. No.: US 2005/0235857 A1
(43) Pub. Date: Oct. 27, 2005

(54) Printing press arrangement

(75) Inventors: Josef Zeinhofer, Maulburg (DE); Hermann Spohn, Eimeldingen (DE)

Correspondence Address: VENABLE LLP, P.O. BOX 34385, WASHINGTON, DC, 20045-9998, US

(73) Assignee: MULLER MARTINI HOLDING AG, Hergiswil (CH)

(21) Appl. No.: 11/101,611

(22) Filed: Apr. 8, 2005

(30) Foreign Application Priority Data
Apr. 26, 2004 (EP) EP 04405257.9

(51) Int. Cl. B41F 33/16

(52) U.S. Cl. 101/484

(57) ABSTRACT

A printing press arrangement comprises at least one printing press including a control device and an input. At least one auxiliary system is provided that includes a control device. At least one system interface is provided for connecting the control device for the printing press to the control device for the auxiliary system. Data is exchanged continually between the printing press and the auxiliary system, thus permitting a joint operation and data management.

### CROSS-REFERENCE TO RELATED APPLICATION

This application claims the priority of European Patent Application No. 04405257.9-125, filed on Apr. 26, 2004, the subject matter of which is incorporated herein by reference.

### BACKGROUND OF THE INVENTION

The invention relates to an arrangement, comprising at least one printing press provided with a control device and input means, as well as at least one auxiliary system provided with an additional control device.

Owing to the complex designs of printing presses, more and more process-technical data must be input, particularly if auxiliary systems are used as separate systems.

Auxiliary systems of this type include, for example, a register control, a color-zone adjustment, a paper-web control, or a video monitoring device. Arrangements comprising several auxiliary systems therefore require the extremely involved input of multiple data. In addition, complex systems of this type require correspondingly long set-up times and the use of maculature is high, thus resulting in a considerable cost increase for each order which is particularly important when processing smaller orders.

### SUMMARY OF THE INVENTION

It is therefore an object of the present invention to create an arrangement of the aforementioned type which avoids the above-listed disadvantages. In particular, the invention noticeably reduces the set-up time for arrangements provided with one or more auxiliary systems.

The above and other objects are achieved according to the invention by the provision of an arrangement comprising:

at least one printing press including a control device and an input; at least one auxiliary system including a control device; and at least one system interface for connecting the control device for the printing press to the control device for the auxiliary system.

The arrangement according to the invention is thus provided with at least one system interface for connecting the auxiliary system to the printing press. The invention permits the exchange of order data and processing data between the two control devices and thus between the printing press and the at least one auxiliary system and avoids the multiple input of data. The system interface “links” the at least one auxiliary system with the printing press and additionally permits a joint data base and order management, wherein the database can be managed centrally or locally.

The invention considerably simplifies the operation by noticeably reducing the set-up time and the use of maculature, thereby allowing a more cost-effective processing of small orders in particular. It furthermore turns out that the invention increases the operational safety, even for extremely complex arrangements comprising a plurality of auxiliary systems and a plurality of printing presses.

According to one modification of the invention, data can be input selectively either at the input for the printing press or at the input for the auxiliary system.

The arrangement is preferably designed such that additional auxiliary systems can be integrated. An arrangement originally provided with only one auxiliary system can thus be expanded easily by adding additional auxiliary systems.

According to a further modification of the invention, the corresponding data for predetermined changes can be harmonized between the printing press and the auxiliary system. For example, it is sufficient to input a color sequence either at the printing press or at the respective auxiliary system, wherein the harmonization of data between printing press and auxiliary system occurs automatically.

According to yet another modification of the invention, all order data for the printing press and the auxiliary system must coincide at any point in time. As a result, the data entered at the printing press and the data entered at the auxiliary system are always current.

It is preferable if all relevant processing data for a production coincide at any point in time for the printing press and the auxiliary system and/or systems, meaning they are always current. As a result, the input is simplified even further.

According to another modification of the invention, the complete data for adjusting the printing press and the auxiliary system or systems are also used for a repeat order. For example, a repeat order of this type can be loaded at the printing press. The order itself can be stored on a local drive for the printing press or can be downloaded from a network.

The orders are preferably loaded via a standard dialog and by accessing a storage such as a hard drive, a disk, or a network, wherein the individual orders are preferably expanded automatically by the specific order data for the auxiliary systems.

The printing press in particular may be an offset printing press while the auxiliary system may be a color-zone adjustment device, a register control, a video monitoring device, a paper web control or wash system.

The interface is preferably designed as an electrical connector and the auxiliary system is provided with a corresponding contact plug.

The above and other objects are further accomplished in the context of a printing press arrangement comprising at least one printing press including a control device and an input and at least one auxiliary system including a control device, wherein there is provided a method comprising: connecting the control device for the printing press to the control device for the auxiliary system via at least one system interface.

### BRIEF DESCRIPTION OF THE DRAWING

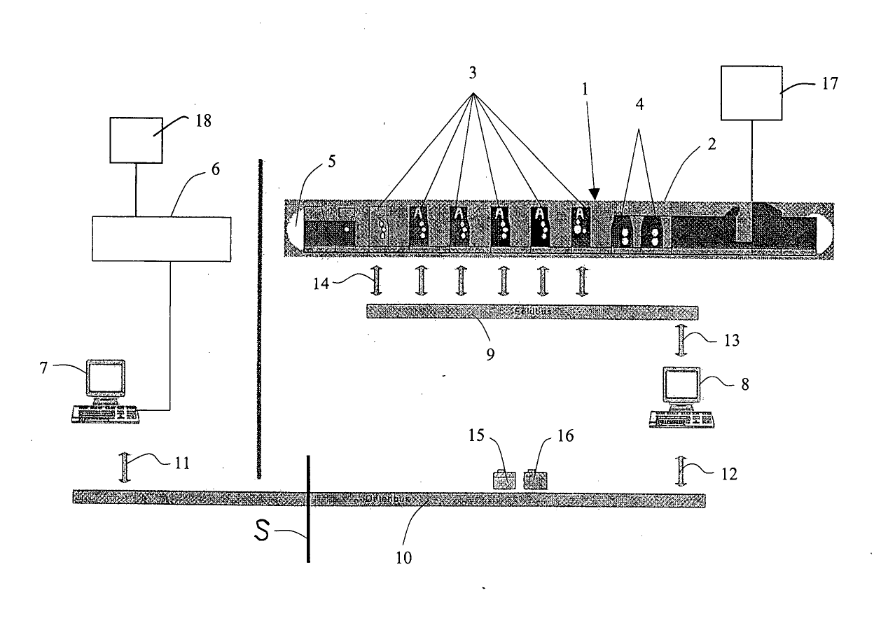

In the following, an exemplary embodiment of the invention is explained with the aid of FIG. 1 which schematically shows the arrangement according to the invention.

### DETAILED DESCRIPTION OF THE INVENTION

The arrangement 1 shown in FIG. 1 comprises a printing press 2 which is provided with several print units 3, known per se, and arranged sequentially in a row. The print units 3 in this case are provided with cylinders that are not shown in further detail herein, in particular a rubber blanket cylinder, a plate cylinder, and a counter-pressure cylinder which are positioned inside a slide-in unit. In addition, the print units 3 are provided with an inking unit. A paper web is pulled off a paper roll 5 and passes through the print units 3. Machine stations 4 can also be provided for the further processing of the paper web, e.g. for punching holes or perforating. The print units 3 are connected to each other by a field bus 9 which functions to receive and transmit digital data between the print units 3. The printing press 2 is controlled by a control device 17. An operating device 8, for example comprising a keyboard for the input and a display, is used for entering data and in particular order data. A double arrow 13 indicates the exchange of data between the operating device 8 and the field bus 9.

The arrangement 1 comprises at least one auxiliary system 6 provided with a control device 18. The auxiliary system 6 is used, for example, for adjusting the color zone at the aforementioned ink duct and/or the ink ducts for controlling the lateral or horizontal registers, as well as for the video monitoring or the paper-web control. It is furthermore possible to provide a plurality of such auxiliary systems 6. The arrangement 1 can comprise, for example, an auxiliary system 6 for the color zone adjustment and simultaneously also an auxiliary system for the paper-web control. The auxiliary system 6 is operated by an operating device 7 which also comprises a keyboard and a monitor or the like. A field bus, not shown herein, is preferably used to connect a plurality of auxiliary systems 6.

The arrangement 1 includes a data bus 10 having an interface S disposed between the printing press 2 and the auxiliary system 6. Digital data is transmitted and received between the printing press 2 and the auxiliary system 6 by data bus 10. The digital data in particular relate to process data 15 and order data 16. Double arrows 11 and 12 show the exchange of data via data bus 10 between the auxiliary system 6 and the printing press 2. The interface S allows the selective operation of the auxiliary system and/or systems 6 by the control 17 or, as in the past, by means of the control 18. The interface S takes the form of a connector that is not shown herein. The auxiliary system 6 is provided with a contact plug which fits into a socket on the printing press 2. In principle, it is also possible to provide several interfaces and/or plug-and-socket connections. In place of the plug-and-socket connection, it is also possible to establish a wireless connection, e.g. by a waveguide, radio, infrared light, or the like.

An order may contain, for example, generally applicable order data such as order reference, order numbers, order description, color sequence, plate sequence, turn-ins, delivery, and paper weight, wherein these data are stored in a memory for a repeat order and are downloaded at the printing press 2. The order itself can be stored on a local drive of the printing press 2 or can be downloaded via a network. In case of changes, the data for the auxiliary system 6 and the printing press 2 are harmonized to avoid multiple inputs.

In the past the printing press 2 and the auxiliary system 6 had to be operated separately. The arrangement 1 according to the invention now permits a joint operation because of the harmonization of the two systems and the continuous exchange of data. With a plurality of auxiliary systems 6, the processing sequences for these auxiliary systems 6 can be controlled and harmonized relative to each other and relative to the printing press 2 and can thus be centrally managed.

Also conceivable is an embodiment comprising a plurality of printing presses 2 that are respectively provided with several auxiliary systems 6. The operational safety is furthermore increased because of the central administration and harmonization of data. The respective data at the printing press 2 and the auxiliary systems 6 are harmonized for any changes to a printing press 2 or an auxiliary system 6. The order data for all printing presses 2 and auxiliary systems 6 are preferably harmonized and are kept current. Orders are advantageously downloaded via a dialog and by accessing a memory. It is therefore conceivable to have an embodiment with continuous data exchange between a plurality of printing presses 2 and a plurality of auxiliary systems 6, which are furthermore operated jointly.

It will be understood that the above description of the present invention is susceptible to various modifications, changes and adaptations, and the same are intended to be comprehended within the meaning and range of equivalents of the appended claims.

1. A printing press arrangement, comprising:
at least one printing press including a control device and an input;
at least one auxiliary system including a control device; and
at least one system interface for connecting the control device for the printing press to the control device for the auxiliary system.

2. The arrangement according to claim 1, wherein data can be input selectively at the input for the printing press or an input for the at least one auxiliary system.

3. The arrangement according to claim 1, wherein the respective data for the printing press and the auxiliary system are harmonized for predetermined changes.

4. The arrangement according to claim 1, wherein substantially all data belonging to an order for the printing press and the auxiliary system coincide at any point in time.

5. The arrangement according to claim 1, wherein process data for the printing press and the at least one auxiliary system coincide at any point in time during a production process.

6. The arrangement according to claim 1, wherein a repeat order can be loaded into the printing press which contains a complete set of data for adjusting the printing press and for adjusting the at least one auxiliary system.

7. The arrangement according to claim 1, wherein orders can be loaded via a dialog and can be stored and that a memory can be accessed for this.

8. The arrangement according to claim 7, wherein the orders can respectively be expanded to include order data specifically designed for the at least one auxiliary system.

9. The arrangement according to claim 1, wherein the printing press is an offset printing press.

10. The arrangement according to claim 1, wherein the at least one auxiliary system comprises a plurality of auxiliary systems linked to each other by a field bus.

11. The arrangement according to claim 1, wherein the auxiliary system enables at least one of a color-zone adjustment, register control, video monitoring, or paper-web control.

12. The arrangement according to claim 1, wherein the at least one auxiliary system is operated by the control for the printing press.

13. The arrangement according to claim 1, wherein the interface comprises an electric connector.

14. The arrangement according to claim 1, comprising a plurality of printing presses and a plurality of auxiliary systems between which data is exchanged continuously and which are operated jointly.

15. The arrangement according to claim 1, wherein the at least one auxiliary system includes a plurality of auxiliary systems linked to each other by a field bus.

16. In a printing press arrangement comprising at least one printing press including a control device and an input and at least one auxiliary system including a control device, a method comprising:
connecting the control device for the printing press to the control device for the auxiliary system via at least one system interface.

17. The method according to claim 16, including selectively inputting data at the input for the printing press or at an input for the at least one auxiliary system.

18. The method according to claim 16, including harmonizing the respective data for the printing press and the auxiliary system for predetermined changes.

19. The method according to claim 16, including coinciding substantially all data belonging to an order for the printing press and the auxiliary system at any point in time.

20. The method according to claim 16, wherein process data for the printing press and the at least one auxiliary system coincide at any point in time during a production process.

21. The method according to claim 16, including loading a repeat order into the printing press which contains a complete set of data for adjusting the printing press and for adjusting the at least one auxiliary system.

22. The arrangement according to claim 16, including loading orders via a dialog, storing the orders in a memory, and accessing the orders from the memory.

23. The method according to claim 22, including expanding the respective orders to include order data specifically designed for the at least one auxiliary system.

24. The method according to claim 16, wherein the printing press is an offset printing press.

25. The method according to claim 16, including linking a plurality of auxiliary systems to each other by a field bus.

26. The method according to claim 16, including enabling at least one of a color-zone adjustment, register control, video monitoring, or paper-web control via the auxiliary system.

27. The method according to claim 16, including operating the least one auxiliary system by the control for the printing press.

28. The method according to claim 16, wherein the interface comprises an electric connector.

29. The method according to claim 16, including operating jointly a plurality of printing presses and a plurality of auxiliary systems, and exchanging data continuously among the plurality of printing presses and the plurality of auxiliary systems.

30. The arrangement according to claim 16, including linking a plurality of auxiliary systems linked to each other by a field bus.
